(19) United States
(12) Patent Application Publication
(10) Pub. No.: US 2006/0155611 A1
(43) Pub. Date: Jul. 13, 2006

(54) System and a method for controlling the quality of business applications

(75) Inventor: Jean Hoffenberg, La Celle St. Cloud (FR)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 11/296,934

(22) Filed: Dec. 8, 2005

(30) Foreign Application Priority Data
Dec. 10, 2004 (FR) 04/13172

(51) Int. Cl. G06Q 30/00

(52) U.S. Cl. 705/26

(57) ABSTRACT

A system and a method for controlling the quality of a set of computerized business applications. The system comprises at least one integrator device (10) suitable for automatically processing at least one type of data item to define at least one user reference table for associating all of the data corresponding to each of said users; at least one questionnaire manager (13) suitable for automatically managing all of the questions and all of the replies corresponding to said computerized business applications being surveyed; at least one calculation device (14) suitable for automatically calculating at least one satisfaction index; at least one data warehouse (15) suitable for dynamically analyzing the replies that are defined directly by said users; at least one categorization engine (16) suitable for automatically allocating a reference signature to each of said open questions in order to represent a reply category; and at least one modeling engine (17) suitable for automatically generating at least one explanatory variable for explaining said satisfaction index of the users questioned for said computerized application being surveyed. The users of a set of computer applications made available to them in a business can be questioned in order to detect malfunctions, in order to measure performance, and in order to determine its suitability compared with the needs of the users.

### FIELD OF THE INVENTION

The present invention relates to a system and a method for controlling the quality of computerized applications in a large business.

The invention applies more particularly to interrogating the users of a set of computer applications made available to them in a business in order to detect malfunctions, in order to measure performance, and in order to determine suitability relative to the needs of the users.

### BACKGROUND OF THE INVENTION

At present, polling organizations begin by defining a predetermined questionnaire that is specific to a topic being surveyed. Thereafter, using the predetermined questionnaire, they put questions to a sample of users concerned by the topic of the survey. The sample of users must also be representative of the various types of user (different age groups, different social categories, etc. . . . ). The result obtained from the replies to the questionnaire constitutes a representation at a given instant of the opinions of the users questioned and the problems mentioned. This representation is valid solely for the time at which the users were questioned. The people being questioned must reply to a questionnaire that is completely unvarying and they must reply in full, with all questions and all possible replies being predefined in advance.

In addition, since the sample of users surveyed is fully controlled, unexpected or unforeseen situations or phenomena are unlikely to be detected. Finally, users are often questioned “manually”, either by meeting them face to face, or in a telephone conversation. Consequently, the cost of such surveys is generally very high given the large number of interviewers needed to avoid the questioning taking place over a period that is too long and in order to be able to analyze the results quickly. In spite of everything, there is an unavoidable minimum period of time between beginning a survey and obtaining results. This period of time, which is at least several days long, is not compatible with the requirements for managing and controlling computerized applications as used in a business.

Furthermore, there also exist surveys carried out on communications networks such as the Internet. A questionnaire, likewise predetermined, is then defined in the form of web pages. The predetermined questionnaire is made available on line on a web server and is accessible to all users of said communications networks during a determined length of time. Compared with a survey of the above-described kind, such on-line surveys are very inexpensive, but there is often no control over which people reply to the survey.

Unlike a manual survey, an on-line survey is an ongoing representation as increasing numbers of users of said communications network access the questionnaire and make replies. However, the originator of the questionnaire has no control over the sample of users who reply. Usually only users familiar with the communications network are going to access such a survey. Consequently, the representivity of the users surveyed is not good, and it is difficult to measure the quality and the pertinence of that representivity, thereby leading to distortions in the results obtained. Under such circumstances, lack of control over the sample of users does not enable such surveys to be used as reliable means for controlling the quality of computerized applications used in a business.

### SUMMARY OF THE INVENTION

One object of the present invention is to provide a system and a method for controlling the quality of a set of computerized business applications, making it possible to remedy the drawbacks of existing systems, while guaranteeing that the users questioned are representative, and while taking account of both expected and unexpected situations in managing computerized applications in a large business.

This and other objects are attained in accordance with one aspect of the present invention directed to a system comprising at least one integrator device suitable for processing at least one data item corresponding to each of the users of said computerized applications and for automatically defining at least one user reference table for associating all of the data corresponding to each of said users; at least one questionnaire manager suitable for automatically managing all of the questions and all of the replies corresponding to said computerized business applications being surveyed; at least one calculation device suitable for automatically calculating at least one quality indicator and at least one analysis axis from said replies to at least one questionnaire in order to provide at least one satisfaction index; at least one data warehouse suitable for dynamically analyzing the replies that are defined directly by said users; at least one categorization engine suitable for automatically allocating a reference signature to each of said open questions in order to represent a reply category; and at least one modeling engine suitable for automatically generating at least one explanatory variable for explaining said satisfaction index of the users questioned for said computerized application being surveyed.

Another aspect of the present invention is directed to a method of controlling the quality of a set of computerized business applications comprising the steps of using at least one integrator device to store in a database at least one data item corresponding to each of said users of said computerized business applications; automatically processing said stored data items to make them consistent and to define at least one user reference table in said integrator device; using at least one questionnaire manager to send automatically to said users at least one questionnaire; using at least one calculation device to calculate automatically at least one quality indicator and at least one analysis axis on the basis of the replies to said questionnaire as a function of all of the fields selected by said business; using at least one data warehouse to analyze dynamically the replies that are defined directly by said users; using at least one categorization engine automatically to analyze at least one open question in order to allocate a reference signature to each of said open questions; and using at least one modeling engine automatically to generate at least one explanatory variable for explaining at least one satisfaction index of the users questioned concerning said computerized application being surveyed.

Thus, said quality control system and method in accordance with the invention make it possible to send at least one questionnaire automatically to the users of at least one computerized application used in a large business. All of the data existing in various different equipments A, B, . . . , X of the business is stored by said quality control system. This data makes it possible to analyze the replies received for said questionnaire. A satisfaction index given by the users of said computerized applications is calculated by the calculation device. The results are also put into form and classified relative to quality indicators and analyses axes. A data warehouse enables the results obtained for the users to be made available. The categorization engine allocates reply categories. Finally, the modeling engine generates explanatory variables for generating priorities concerning the problems mentioned by the users questioned, and regardless of whether those problems were or were not to be expected.

All of this information is stored in at least one database. It is also accessible by users on an internal site of the business network.

In the invention, said questionnaire is sent to a fraction of said users of the computerized business applications, said fraction being selected automatically and randomly by said integrator device.

In the invention, said questionnaire is self-adaptive, adapting itself as a function, separately or in combination: of said questioned user; of said computerized application being surveyed; of at least one reply given to an earlier question; and/or of the loyalty of said questioned user.

The integrator device selects, automatically and randomly, by drawing lots, a fraction of said users of the computerized business applications in order to send them at least one questionnaire. Not all of the users are interrogated. Fractions of said users are surveyed in turns in successive polls.

The list of users interrogated periodically, e.g. monthly, is defined in random manner in said integrator device and is stored in the database. This list may include new users for questioning and may serve to send reminders to users questioned in previous months and who have not yet replied.

The questionnaire is dynamic as a function of the users and the applications to which the replies relate. Unlike a set list of questions, the questionnaire manager establishes and manages said questionnaire, thus enabling the questionnaire to be individualized as a function of the person being questioned. The choice of questions is also a function of the computerized business applications being surveyed. The questionnaire is dynamic, self-adaptive, and contextual. It adapts itself as a function of the replies given to one or more earlier questions. It can also be different depending on whether or not the person being questioned is replying to a questionnaire for the first time.

In accordance with the invention, anonymity is guaranteed for the users questioned by means of said questionnaire.

Since users are selected automatically and randomly by said integrator device, they can remain anonymous when replying to the questionnaire. Storage of the replies to the questionnaire in the database is undertaken by means of secure transmission, thereby guaranteeing said anonymity and data security.

Similarly, when processing open questions and the replies thereto, messages can be sent automatically to the people in charge of the applications being surveyed so that account can be taken of said replies. This transmission can be undertaken by said quality control system while preserving anonymity of the users questioned by means of said questionnaire, by not specifying the name of the user being questioned.

In the invention, the replies to said questionnaire are processed, put into form, and made available almost in real time for said users of the business and they are stored in said database.

Said calculation device and said data warehouse process the replies to the questionnaire, and calculate quality indicators and analyses axes as a function of fields selected by the business in order to determine a satisfaction index for the computerized applications being surveyed.

The results are thus prepared so as to give the results of analyses almost in real time and dynamically and so as to give almost instantaneous access to the quality of the computerized business applications.

In accordance with the invention, said modeling engine groups together stored data that is not directly related to said computerized business applications or to said questionnaire in order to search for said explanatory variables.

One of the advantages of said quality control system is to receive data about the users, about the computerized applications, about the organization of the business, etc. . . . , and to group this data together so as to analyze the results with greater pertinence, explain the satisfaction indices, and enable decisions to be taken on the basis of the results. The results are sent to the people in charge of the business, together with proposals for actions and decisions to be taken.

### BRIEF DESCRIPTION OF THE SINGLE DRAWING

FIG. 1 presents the general architecture of a quality control system in accordance with the invention for a set of computerized business applications.

### DETAILED DESCRIPTION OF THE SINGLE DRAWING

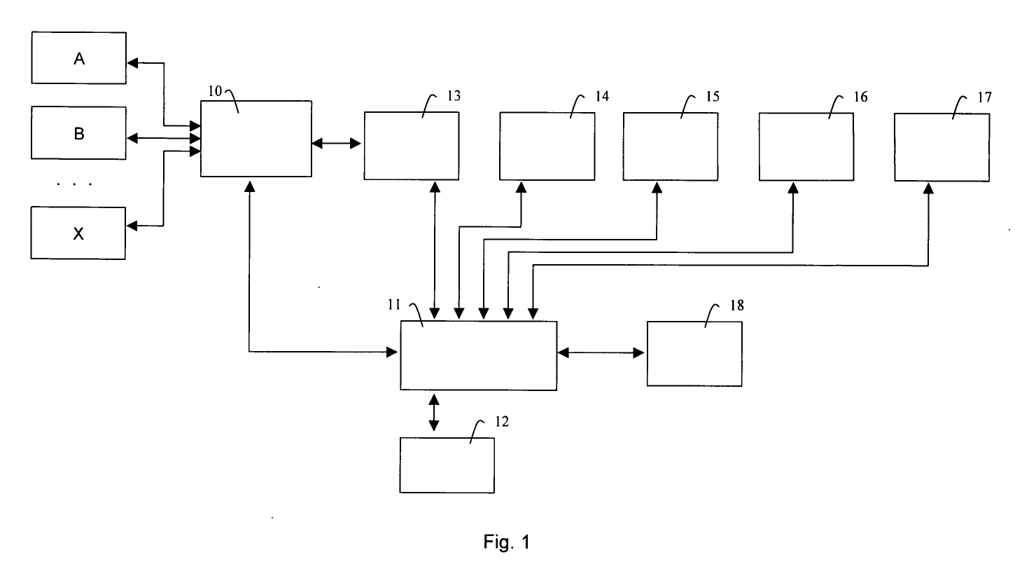

A quality control system in accordance with the invention for a set of computerized business applications comprises at least one integrator device 10, at least one questionnaire manager 13, at least one calculation device 14, at least one data warehouse 15, at least one categorization engine 16, and at least one modeling engine 17, said system being shown in FIG. 1.

The system also comprises at least one database 11 for storing all of the data needed for the operation of said system. Said database 11 may optionally be physically included in said quality control system.

Said system may also comprise at least one inquiry device 12 for setting up the calls required between the system of the invention and the users of the business. At least one inquiry device 12 is fitted with at least one transmission means for communicating between users of the business and said quality control system. Said inquiry device 12 may be physically included in said quality control system. However one or more inquiry devices 12 external to said system may be controlled by the integrator device 10, particularly when one or more such devices already exist in the business. Said inquiry device 12 can likewise optionally be included in the integrator device 10.

A business information system (IS) comprises all of the equipments and applications that contribute to processing and managing information within the business (databases, applications software, etc. . . . ), including the computer system proper, and in particular all of the computerized applications of the business.

The integrator device 10 receives and stores in said database 11 at least one data item corresponding to each of the users of said computerized applications of the business. Said integrator device 10 manages all of the data relating to the interrogated users of the IS. This data is communicated by various equipments A, B, . . . , X, of the business, in particular systems for managing human resources (HR), directories of business personnel, e-mail directories, business organization charts including the various entities and the functions that exist between them, the list of references corresponding to the professions and the workstations of the business, etc.

The integrator device 10 takes account of all kinds of organization, regardless of the field of activity of the business and regardless of the natures of the equipments A, B, . . . , X specific to each business. It adapts to variations over time of said business organization. In particular, it manages organizations in recursive manner, i.e. taking account of the fact that a person forms part of a service S1, which service S1 is itself included in another service S2, which service S2 is integrated in an entity, . . . , and so on repeating levels an undefined number of times.

Said integrator device 10 also receives the list of computer applications made available to employees of the business, and the functions of those applications and the professions or workstations for which they are intended. These computerized applications can be of any kind, whether standard and very well known, or very specific and highly unusual, in particular in a large business. These applications can equally well be used by large numbers of users in the business, or by only a few people.

For the management of each of these computerized applications, both for maintenance purposes and for updating, the list also includes an indication of the people responsible for specifying what the applications are to do, i.e. the software “clients”, and of the people responsible for implementing the applications, i.e. the software “contractors”. This list may include all of the information associated with the applications, such as the existence of a user manual, possible access to on-line help, the availability of a direct “hotline” for maintenance, the number of people capable of identifying breakdowns on an application, etc. Finally, the list includes technical information concerning access and management of users for these computerized applications, such as Internet protocol (IP) addresses, on the internal network of the business, the proxy equipments used, the information that exists in the hypertext transfer protocol (HTTP) headers used for message transmission, etc.

Said integrator device 10 can automatically receive all of said data, e.g. because of communications routines that exist in the integrator device 10 and the equipments A, B, . . . , X. It may also interrogate the various equipments A, B, . . . , X automatically and periodically or in real time, e.g. for regular updates. The integrator device 10 is configured to communicate with said business equipments A, B, . . . , X so as to receive data about said business. The integrator device 10 is fitted with various communications interfaces (for transmission and reception) with the various equipments A, B, . . . , X of the business in order to communicate said data.

Said database 11 serves to save all of the data received. It may optionally be physically included in said integrator device 10. The integrator device 10 is configured to transfer said data to said database 11 for storage purposes.

The integrator device 10 automatically processes said stored data to make it consistent and to define a user reference table. It makes logical associations between data items that have non-explicit connections between one another for a given user. For example, an e-mail address is associated with the human resources (HR) information for that person. For each user, a reference table holds all of the data received about that user, so as to obtain a representation that is as exact as possible and as broad as possible of the population and computer applications to which the quality control applies. The integrator device 10 thus automatically defines said user reference tables to associate all of the data corresponding to each of said users of the computer applications of the business. After being made consistent, said user reference tables are also stored in the database 11.

The integrator device 10 includes at least one sequencer which controls the actions to be undertaken by the other equipments of said system at the appropriate times. To do this, said integrator device contacts each of the various equipments making up said quality control system in accordance with the invention.

From the stored data, said integrator device 10 then selects automatically and randomly, by drawing lots, a fraction of said users of the computer applications of the business in order to send them at least one questionnaire. Not all of the users are questioned. A fraction of said users are questioned successively, in turn.

The list of said selected users is sent by the integrator device 10 to at least one questionnaire manager 13. The integrator device 10 is configured to dialog with said questionnaire manager 13. The users being questioned receive a questionnaire to complete, and in general they receive the address of a link for accessing said questionnaire on line on the internal server of the business. Said questionnaire manager 13 automatically sends said questionnaire to the selected users of the business via said inquiry device 12.

The questionnaire manager 13 establishes communication between said quality control system and the users of the business being questioned. It serves to send messages automatically to the users by e-mail and/or fax, for example using an automatic e-mail generator.

The questionnaire is dynamic as a function of the users and the applications to which the replies relate. Unlike a set list of questions, the questionnaire manager 13 establishes and manages said questionnaire in the same manner as the systems that are generally used for electronic trading, e.g. transaction authentication systems, thus enabling the questionnaire to be individualized as a function of the person answering it. The choice of questions depends on the computer applications of the business that the user mentions.

In addition, the questionnaire is dynamic, self-adaptive, and contextual. As the questions are asked, the questionnaire adapts as a function of the replies given to one or more preceding questions. It is also different depending on whether the person is answering the questionnaire for the first time or not. To make users more loyal, said questionnaire recognizes a user who has already given answers and personalizes the questionnaire as a function of the loyalty of said user. Consequently, said questionnaire develops so as to adapt as a function of the user being questioned, and/or as a function of the computer application concerned, and/or as a function of at least one reply given to an earlier question, and/or as a function of the loyalty of said user being questioned. All of the replies to the questionnaire are automatically stored in said database 11.

One of the advantages of said quality control system is the ability to transmit a questionnaire to a large number of users. For example, for a large business having about 100,000 people, a questionnaire of about 80 questions can be sent once a month to 20,000 users at a cost that is low, corresponding to one user of the network infrastructure of the business.

The list of users questioned periodically, e.g. once a month, is defined randomly in said integrator device 10 from the list of user reference tables stored in the database 11. This list can include new users to be questioned and can send reminders to users questioned in earlier months and who have not replied.

Said processing of a large number of replies is performed very quickly. This is made possible by the technologies used for the questionnaire that include the functions normally implemented by a server. This makes it possible to multiply the power of the questionnaire manager 13 by the number of user terminals interrogated with the processing being off-loaded to the terminals of the users. For example, help for the various choices, and parameters are off-loaded to the terminals of said users. This technical characteristic makes it possible to reduce considerably the load on the questionnaire manager 13 managing said questionnaire.

In addition to its dynamic and self-adaptive nature, the questionnaire includes questions that are open, referred to as “verbatims”, where the response is in the users' own words and is not limited in size, in addition to those questions referred to as “closed” that have a limited number of predefined choices for replies. Consequently, said questionnaire manager 13 can automatically manage all of the questions and all of the replies corresponding to said computerized business applications concerned by the quality control operations.

Finally, since users are selected automatically and randomly by said integrator device 10, they can remain anonymous when replying to the questionnaire. The replies to the questionnaire are stored in the database 11 via secure transmission so as to guarantee such anonymity and to secure the data. Said quality control system guarantees anonymity for the users questioned by the questionnaire. In general, said questionnaire manager is configured to dialog with said integrator device 10 so as to dialog with and control said inquiry device 12 for transferring said data to said database 11 and storing it therein.

In addition, the replies to the questionnaire are automatically accessible on an internal network server of the business, e.g. on an Intranet web site, that receives the information coming from the database 11 and that results from calculations performed periodically by the calculation devices 14.

At least one calculation device 14 receives the replies to the various questions of said questionnaire coming from said questionnaire manager 13. Said questionnaire manager 13 is configured to dialog with said calculation device 14 and transfer answers thereto. The calculation device periodically calculates quality indicators and analysis axes from the replies to the questionnaire and as a function of a set of fields selected by the business so as to give at least one satisfaction index. The quality indicators serve to quantify the value of a reply, for example as a function of the user's profession or the organizations to which the user belongs or any other personal characteristics relating to the user. The analysis axes serve to classify replies as a function of fields or domains. Fields are selected by the business, for example a particular computerized application, an organization within the business, the hierarchical level of the user being questioned, the architecture of the network used, the nature of the user's workstation, etc. In practice, said calculation device 14 can be implemented from a work flow system (for automatically controlling an ordered sequence of successive tasks) on a structured query language (SQL) server.

The calculation device 14 works on the results obtained from said questionnaire and presents them in the form of standard office files (e.g. in Word, Excel, or Access format), so as to make the data easier to use as a function of the quality indicators and the analysis axes. Said results make it possible to calculate at least one satisfaction index per application under investigation and make it possible to draw up a list of detected malfunctions. The office files and the satisfaction indices are also accessible over the internal network of the business, which is accessible automatically and in real time. All of the calculations performed are stored in said database 11. In general, the calculation device 14 is configured to dialog with said questionnaire manager 13 with at least one data warehouse 15, and with said integrator device 10 in order to transfer data and store it in said database 11.

Since quality control analyses can be complex, the results from the calculation device 14 are finished off in a data warehouse 15. It centralizes the results obtained from said questionnaire and integrates them with various sources of information about the business (HR, directories, maintenance, network equipment, etc. . . . ), so as to combine and associate the data in order to aggregate it in manners that make it easier to control and follow the quality indicators of the various activities of the business. Said data warehouse 15 dynamically analyses the replies as defined directly by said users of the quality control system and enables the results obtained to be made available to the users.

The results are thus prepared so as to enable the results of dynamic analyses to be made available almost in real time and to give almost instantaneous access to data concerning the quality of the computerized applications in the business, in particular by processing the various quality levels relative to the analysis axes. In particular, the data warehouse 15 makes it possible to visualize the results and to explore through them starting from the general and going towards the particular with ever increasing detail. All of the processing performed is also stored in said database 11.

Thereafter, particular processing is performed for the replies to the open questions (or verbatims), previously analyzed by the calculation device 14 and the data warehouse 15. Said open questions and the replies thereto are sent automatically to the people in charge of the applications in question so that they can take account of said replies. Where necessary, this transmission can be performed while preserving the anonymity of the users questioned by said questionnaire, e.g. by an e-mail from the inquiry device 12 of the quality control system, without notification of the name of the user being questioned.

The way this information is taken into account can relate to functional developments in the application in question, to be undertaken by the client managing the computerized application, or else maintenance actions to be undertaken by the contractor. The maintenance or the developments proposed by the contractor or the client is automatically forwarded to the users concerned that have been questioned. These exchanges of messages are also stored in said database 11 for reminder and supervision purposes for said quality control system.

Consequently, said data warehouse 15 is configured to dialog with said calculation device 14, at least one categorization engine 16, and with said integrator device 10 in order to transfer data to said database 11 and to store it therein.

The replies to open questions (or verbatims) are analyzed using a fully automated categorization engine 16. It constructs a knowledge base by automatic training on the basis of the contents of replies in free form text, taking account of the real language of the users. Said categorization engine 16 gives a reference signature to each reply to an open question. Each reply possesses a reference signature in said knowledge base, which signature represents a category of reply. Thereafter, the categorization engine 16 calculates a reference signature for each new reply it receives and compares them with the reference signatures that already exist. Said reference signatures and the categorization of the replies are stored in said database 11.

The categorization engine 16 is configured to dialog with said data warehouse 15, with at least one modeling engine 17, and with said integrator device 10 to dialog with and control said inquiry device 12, in order to transmit data to said database 11 and store it therein. Said categorization engine 16 automatically analyses at least one open question in order to give a reference signature to each of said open questions, to represent a category of reply.

This categorization of the replies to the open questions enables simple and fast classifications and interrogations to be performed by said quality control system, e.g. to obtain a list of the most-requested modifications for a given application.

Finally, a modeling engine 17 serves automatically to construct at least one model for predicting behavior or phenomena. Said model automatically manages explanatory variables on the basis of the data stored in said quality control system, such as the replies to the survey, personal data corresponding to the users, the user reference tables, the kinds of workstations used by said users, the organization of the business, the processing of open questions, etc. . . . .

The objective of the modeling engine 17 is to explain the final value of satisfaction index for a given day and for a particular application, which index was found from the replies to the questionnaire. The engine also serves to explain variation in said index compared with a previously existing survey. The value of the satisfaction index gives a mean measurement of the satisfaction of questioned users. The explanatory variables provided by said modeling engine 17 make it possible to discover factors associated with satisfaction, or lack of satisfaction, and that explain said value for the satisfaction index. The value of the satisfaction index takes account of direct replies to the questionnaire, such as response times for accessing an application in question. This information is excluded from searches for satisfaction or non-satisfaction factors.

The modeling engine 17 makes it possible to provide an explanation on the basis of the results of the survey and of the detected malfunctions. On the basis of the raw results, it can make associations between data items stored without links so as to search for and extract variables. These variables are revealed from within the very large quantity of said data stored in the database 11. Said explanatory variables are factual elements that are not directly related to the computerized application, such as the activity of the user replying to the questionnaire, the geographical location of the user, the existence of a user guide relating to the application in question, etc. Said explanatory variables are stored in said database 11.

By means of the modeling engine 17 which produces a behavior model as a function of targeted users, it is possible to obtain results that are not given without any explanation. Said modeling engine 17 generates explanatory variables so as to provide priorities amongst the problems raised by the users questioned, regardless of whether those problems are to be expected or are unexpected. In addition to the malfunctions mentioned, information is provided that makes it possible to take decisions on the basis of said result. The previously implemented classification of replies by field (or domain) makes it possible to recognize those malfunctions that are specific to the application in question.

The modeling engine 17 thus automatically generates at least one explanatory variable for explaining at least one satisfaction index applicable to the users questioned about a particular computerized application. It is configured to dialog with said categorization engine 16 and said integrator device 10 in order to transfer data to said database 11 and store it therein.

In addition, by using the very broad-ranging data stored, said modeling engine 17 can detect phenomena that were not predicted or expected. Such phenomena are then associated with data other than the data relating to the application in question and the replies to the questionnaire, such as the technical characteristics of the network as a function of geographical location, or indeed problems of personnel management or human resources. The results are then forwarded to the people in charge of the business with proposed actions and decisions. The modeling engine 17 groups together stored items of data that are not directly associated with said computerized business applications and said questionnaires in order to search for said explanatory variables.

Once the explanatory variables have been extracted, said model is destroyed since it corresponds only to one given situation, associated with the replies given to the questionnaire and the malfunctions indicated at one particular time.

For short-term control needs, e.g. over one day, the modeling engine 17 establishes a model for that day's replies, and then for preceding days, and then for the previous month. If a variable is confirmed, that is indicative of an important fact, a new phenomenon, or a problem that is not being solved.

A computer program, comprising portions of code, is provided for executing the various steps of the method like previously defined, and a computer-readable storage medium having recorded thereon said computer program.

At least one data administrator 18 can be provided in said quality control system in order to make manual control possible, where necessary, and in order to manage reference data. Said data administrator 18 can input decisions concerning questions or control, e.g. a decision to survey an entity in the organization of the business. The data administrator 18 can access the list of users selected for the survey via the integrator device 10. It can add a new computerized application for inspection, when a new application is put into service in the business. It can modify a characteristic for the selected users or add an entity to be surveyed in the organization of the business. It can send particular reminders to the people in charge of the business to find out their opinions by means of the inquiry device 12.

Said data administrator 18 can also access the calculation device 14 to add classification fields. It can also access the categorization engine 16 to add new categories or to correct any classification errors made by said categorization engine 16 so as to improve said knowledge base by training.

The data administrator 18 thus controls adding or removing, separately or in combination, at least one user for questioning, at least one computerized application of the business for a quality control survey, at least one field selected for said calculation device 14, and/or at least one reference signature for said categorization engine 16. It can control, separately or in combination, said integrator device 10, said database 11, said inquiry device 12, said questionnaire manager 13, said calculation device 14, said data warehouse 15, said categorization engine 16, and/or said modeling engine 17.

1. A method of controlling the quality of a set of computerized business applications, the method being characterized in that it comprises the steps consisting in:
automatically storing and processing in at least one integrator device (10) at least one data item for defining at least one user reference table of said computerized business applications;
using at least one questionnaire manager (13) to send automatically at least one questionnaire to said users;
using at least one calculation device (14) and at least one data warehouse (15) automatically to analyze and calculate at least one satisfaction index and to classify results as a function of a set of fields selected by said business;
using at least one categorization engine (16) automatically to analyze at least one open question in order to allocate a response category for classification purposes; and
using at least one modeling engine (17) automatically to generate at least one explanatory variable on the basis of all of the stored data in order to explain said satisfaction index.

2. A quality control method according to claim 1, characterized in that said questionnaire is transmitted to a fraction of said users of the computerized business applications, which fraction is selected automatically and randomly by said integrator device (10).

3. A quality control method according to claim 1, characterized in that said questionnaire is capable of adapting itself as a function, separately or in combination: of said questioned user; of said computerized application being surveyed; of at least one reply given to an earlier question; and/or of the loyalty of said questioned user.

4. A quality control method according to claim 1, characterized in that anonymity is guaranteed for the users questioned using said questionnaire.

5. A quality control method according to claim 1, characterized in that said modeling engine (17) grouped together stored data that is not directly associated with said computerized business applications and said questionnaire when searching for said explanatory variables.

6. A system for controlling the quality of a set of computerized business applications, the system being characterized in that it comprises at least one integrator device (10) suitable for automatically processing at least one type of data item to define at least one user reference table for associating all of the data corresponding to each of said users; at least one questionnaire manager (13) suitable for automatically managing all of the questions and all of the replies corresponding to said computerized business applications being surveyed; at least one calculation device (14) suitable for automatically calculating at least one satisfaction index; at least one data warehouse (15) suitable for dynamically analyzing the replies that are defined directly by said users; at least one categorization engine (16) suitable for automatically allocating a reference signature to each of said open questions in order to represent a reply category; and at least one modeling engine (17) suitable for automatically generating at least one explanatory variable for explaining said satisfaction index of the users questioned for said computerized application being surveyed.

7. An integrator device (10) suitable for being implemented in a system according to claim 6, characterized in that it is configured to communicate with at least one equipment (A, B, . . . , X) of the business to receive data about said business, to send data to said database (11) and store it therein, and to dialog with said questionnaire manager (13).

8. A questionnaire manager (13) suitable for implementation in a system according to claim 6, characterized in that it is configured to dialog with said integrator device (10), to dialog with and control said inquiry device (12), to dialog with and transmit to said calculation device (14), and to send data to said database (11) for storage therein.

9. A calculation device (14) suitable for being implemented in a system according to claim 6, characterized in that it is configured to dialog with and transmit to said questionnaire manager (13), said data warehouse (15), and said integrator device (10), and to transmit data to said database (11) for storage therein.

10. A data warehouse (15) suitable for being implemented in a system according to claim 6, characterized in that it is configured to dialog with and transmit to said calculation device (14), said categorization engine (16), and said integrator device (10), and to transmit data to said database (11) for storage therein.

11. A categorization engine (16) suitable for being implemented in a system according to claim 6, characterized in that it is configured to dialog with and transmit to said data warehouse (15), said modeling engine (17), and said integrator device (10), to dialog with and control said inquiry device (12), and to transmit data to said database (11) for storage therein.

12. A modeling engine (17) suitable for being implemented in a system in accordance with claim 6, characterized in that it is configured to dialog with and transmit to said categorization engine (16) and said integrator device (10) to transmit data to said database (11) for storage therein.

13. A computer program, characterized in that it comprises portions of code for executing the steps of the method according to claim 1.

14. A computer-readable storage medium having recorded thereon said computer program according to claim 13.
